(19) United States
(12) Patent Application Publication
(10) Pub. No.: US 2012/0132673 A1
(43) Pub. Date: May 31, 2012

(54) Foam Resistant Keg Dispenser

(76) Inventor: Robert Leyva, Roswell, NM (US)

(21) Appl. No.: 13/025,090

(22) Filed: Feb. 10, 2011

Related U.S. Application Data
(60) Provisional application No. 61/337,841, filed on Feb. 12, 2010.

(51) Int. Cl. B67D 7/80; B67D 1/16

(52) U.S. Cl. 222/146.6; 222/108

(57) ABSTRACT

A keg dispenser for dispensing and housing a beverage contained within a keg. The dispenser reduces temperature-induced foam by permitting tap-lines to be properly cooled.

### CROSS-REFERENCE TO RELATED APPLICATIONS

This application claims priority to and the benefit of the filing of U.S. Provisional Patent Application Ser. No. 61/337,841, entitled “FOAM RESISTANT KEG DISPENSER”, filed on Feb. 12, 2010, and the specification thereof is incorporated herein by reference.

### BACKGROUND OF THE INVENTION

1. Field of the Invention (Technical Field)

There are typically two types of keg dispensers readily available for home use. One, in its simplest form, is a boxed refrigerator with a column setting on top. The “column”, as it is generally referred to within the beer industry, is a cylindrical tube having an outside diameter of approximately four inches and an inside diameter of approximately three inches. The column is normally disposed on top of a refrigerated housing comprising tubing that connects the keg to the spigot. The tubing also limits airflow through the column. A spigot is also attached to the column. Aside from an unsightly appearance, such a configuration also makes it difficult to adequately cool the section of tubing housed within the column. Because beer which is not properly cooled has a tendency to foam excessively when dispensed into a drinking container, such known devices are plagued with chronic foaming. To combat this problem, some high-end residential units utilize a separate blower which forces cool air directly into the column in order to minimize foaming. However, this additional hardware increases the cost of the unit, thereby preventing the average consumer from purchasing it.

The second type of dispenser is a modified refrigerator with the spigot attached directly to the door of the refrigerator. This type is not manufactured. Instead, it is typically sold as a kit to be installed by the purchaser and requires drilling into the front door of a standard residential refrigerator, thereby defacing it and possibly damaging the refrigerator, and likely voiding the manufacture's warranty. Yet another problem with this known arrangement is that average individuals lack the basic knowledge of how draft works, thus making such piecemeal kit-systems problematic. Still further, another aspect of such an arrangement, viewed by some as unfavorable, is having the spigot and drip tray protrude from the front of the refrigerator door where aside from being unsightly, could prove to be a possible hazard (i.e. snagging of clothing or injury due to bumping with force).

While there may be other arrangements for dispensing kegs, they are typically reserved for commercial use due to the high cost of the equipment, installation and high maintenance associated with running such devices; they are not conducive for use in a residential setting.

Ideally, a keg dispenser should be easy to operate and maintain with little or no issues with product loss due to foam and should be aesthetically pleasing.

2. Description of Related Art

Note that the following discussion refers to a number of publications by author(s) and year of publication, and that due to recent publication dates certain publications are not to be considered as prior art vis-a-vis the present invention. Discussion of such publications herein is given for more complete background and is not to be construed as an admission that such publications are prior art for patentability determination purposes.

U.S. Pat. No. D 469,787 to Wicker discloses a keg cooler ornamental in design where the dispenser has a cylindrically contoured front to wrap around the keg. The dispenser column, however, is still located on the top outside of the housing thus operating as a typical keg cooler with dispenser column on top of the housing.

U.S. Pat. No. D 352,296 to Westendorf illustrates a keg-shaped keg cooler. Although ornamental, the design serves no utilitarian purpose.

U.S. Pat. No. 6,502,415 to Chiusolo et al. discloses a cooling system requiring the use of water and ice circulated over conduits by agitators to keep beer from foaming. This is arrangement is only useful in an off-grid setting where conventional refrigeration is not available. U.S. Pat. No. 4,225,059 to Kappos, U.S. Pat. No. 3,865,276 to Thompson and U.S. Pat. No. 2,223,152 to Nagin, also describe methods that are useful where typical refrigeration-techniques are not available or not preferred. Both of these systems lack a refrigeration unit, thus making them unsuitable for daily residential or commercial use.

U.S. Pat. No. 7,237,390 to Nelson discloses a portable cooling unit for use during social gatherings. Although the system provides desirable results for events lasting a few days, it is not useful for routine home use, where a keg may last weeks or months before being consumed. This is because Nelson's system fails to cool the entire keg, thus causing the beer to spoil in a short time. This system also lacks the ability to conceal the spigots from the public's view.

Another issue with current keg dispensers is the shear size of the units. For the most part, they are designed to house large ½ barrel kegs, which are typically used in commercial settings. This gives the appearance of a bar or frat house to the location in which they are housed. There are also a growing number of kegs being used to distribute craft or specialty beers. These are known as slim ¼ or slim 5 gallon kegs. These smaller kegs, generally referred to as “slim kegs” are also favored by a growing sect of home brewers. There is currently no known cylindrical dispenser designed specifically for these slim kegs.

There is thus a present need for an apparatus that dispenses slim kegs or typical ½ barrel kegs while maintaining a compact size. Particularly, an apparatus which is easier to maintain and operate and which ensures proper cooling and thus avoids the foaming problems that are so prolific in known keg dispensers. There is further a need for a keg-dispensing apparatus which includes an outer-housing that is shaped to fit within the décor of a home or trendy sports bar.

### BRIEF SUMMARY OF THE INVENTION

An embodiment of the present invention relates to a beverage dispensing apparatus that includes a keg compartment and an upper column having one or more upper doors and a spigot that is concealed when the doors are closed. In one embodiment the keg compartment is cooled by a cooling unit. The cooling unit can operate on the principal of adiabatic cooling of a compressed refrigerant and/or include a Peltier-effect-based thermo electric cooler. In one embodiment, the keg compartment can include a door which has a drip tray disposed in an upper end thereof. The keg compartment can be disposed below the upper column. Optionally, the spigot can be disposed on a front portion of the upper column.

In one embodiment the spigot is not disposed on a top surface of the dispensing apparatus. Optionally, the upper column is not cylindrical. The upper column can have at least two different radiuses of curvature. The upper column can include two upper doors and the keg compartment can include only one door. Optionally, the upper column can include a cool air entrance opening having a cross-sectional area of at least 24 square inches within which at least a terminal portion of a line lies. The cool air entrance opening can be communicably coupled to an interior of the keg compartment and not to ambient air when a door of the keg compartment is closed and the upper doors are open. Optionally, the cool air entrance opening can be communicable with ambient air when a door of the keg compartment is open, but not when the door is closed.

In one embodiment, the spigot can be rotated about a substantially horizontal axis and/or the spigot can include a quick-couple spigot handle. Optionally, a plurality of spigots can be provided. The keg compartment can include internal dimensions which accommodate a plurality of slim kegs. Optionally, a vent can be disposed in the upper column and can be communicable with an area formed between the one or more upper doors and the upper column.

An embodiment of the present invention also relates to a beverage dispensing apparatus having a keg compartment, an upper column that includes one or more upper doors and a spigot that is concealed when the doors are closed; and the dispenser having an elongated cylindrical shape.

An embodiment of the present invention also relates to a beverage dispensing apparatus having a substantially cylindrical shape; a cooled keg compartment; a first spigot communicably coupled to a keg tap; a second spigot communicably coupled to a water source; and the spigots can be secured within a spigot bay that is formed into a portion of the substantially cylindrical shape.

An embodiment of the present invention also relates to a beverage dispensing apparatus having a keg containing compartment, and an upper column, the upper column having a spigot, wherein an outer portion of the upper column is recessed from an outer portion of the keg compartment, thereby forming a rabbeted shape.

An embodiment of the present invention relates to a method and apparatus for dispensing carbonated beverages with minimal foam by properly maintaining the temperature of the carbonated beverage within a desirable range. The apparatus preferably comprises an enhanced column which provides a greater flow of chilled air around a keg. This embodiment can also optionally provide a spigot which can be concealed from view when not in use. Another embodiment of the present invention provides a relatively small foot print, thus requiring less floor space than conventional keg dispensers. One embodiment of the present invention relates to a method and apparatus for dispensing draft beverages e.g. beer, cider, soda, ginger beer, root beer or any other beverage able to be served in through a conventional draft system.

One embodiment of the present invention comprises a keg dispenser. The keg dispenser preferably includes a cylindrical housing which is about 10 to about 24 inches in diameter, and more preferably about 13 to about 15 inches in diameter. The smaller approximate 13″ diameter housing can house a 5 gallon slim keg or a smaller keg while the larger approximate 15″ in diameter can house either a ¼ slim keg, a slim 5 gallon, or a smaller keg. Alternatively, larger diameters can be used and will provide desirable results, including the ability to house one or more full-size half kegs, 5 gallon slim kegs, and/or ¼ slim kegs. Optionally, the housing can have a single or double door wide enough and tall enough for the one or more kegs to be inserted into it. The one or more doors can optionally accommodate a keg which is in an upright position.

In one embodiment, a bottom portion of the housing preferably houses a refrigeration unit. Alternatively, the refrigeration unit can be disposed elsewhere on and/or within the housing. In one embodiment, a portion of the housing can have a rabbet incorporated into it. Optionally, the rabbet can be formed between a substantially vertical surface, upon which a spigot can be mounted, and a substantially horizontal surface, on which a drip tray can be formed.

An alternative embodiment of the present invention provides a locking mechanism, thus providing a user with the ability to hide or lock, under key, the equipment used to dispense and house a keg.

Another embodiment of the present invention provides a draft dispenser having the appearance of a water cooler with or without the ability to dispense water either from a water line or refillable water container. While using this embodiment the water dispensing nozzle can be located on the exterior of the dispenser readily available to all.

Another embodiment of the present invention provides a dispenser with the appearance of a beverage container in the shape of a can or bottle. In this embodiment, the appearance can be adapted to simulate an existing product, such as a commercially-available individual-serving-sized canned product of the dispensed beverage which is commercially available, thus building brand-recognition and product identification among consumers.

One aspect of an embodiment of the present invention provides a draft dispenser with the availability of various colors. This will prove to be useful in displaying team spirit as consuming draft beverages is sometimes associated with watching professional and collegiate sports on television.

Yet another embodiment of the present invention provides a spigot that comprises a quick-connect and quick-release mechanism (for example the mechanism can optionally be similar to those used to connect air tools to air hoses). Optionally, a locking mechanism can be incorporated and/or adapted into the quick-connect housing such that the normal placement of the handle connection for the spigot is prevented from being used.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. For example, although the drawings illustrate only circular and oval cross-sectional-shaped housings, desirable results can also be achieved by virtually any cross-sectional shape capable of housing at least one keg of any size. In the drawings:

FIG. 1 is a perspective-view drawing which illustrates a dispenser according to an embodiment of the present invention wherein its doors are connected with an internal hinge arrangement and wherein a drip tray is disposed within a top-portion of a lower door thereof;

FIG. 2A is a drawing which illustrates an embodiment of the present invention wherein a pair of top doors are open and a door of the keg compartment is closed;

FIGS. 2B and C are drawings which illustrate an embodiment of the present invention; wherein a spigot is concealable within a housing when not in use;

FIGS. 2E and D are drawings which respectively illustrate embodiments of the present invention wherein the dispenser has a bottom door, but not a top door, and wherein the dispenser does not have any doors.

FIGS. 3A and 3B are drawings which respectively illustrate a flow of chilled air within a dispenser wherein a cooling unit disposed at a bottom and a top of the dispenser according to an embodiment of the present invention;

FIGS. 4A and B are drawings which illustrate a size difference between a conventional column and an enhanced column according to an embodiment of the present invention;

FIG. 5 is a drawing which illustrates a rotatable spigot according to an embodiment of the present invention;

FIGS. 6A and B are drawings which illustrate alternative embodiments of the present invention which incorporate a water dispensing-spigot;

FIGS. 7A and B are drawings which illustrate a dispenser according to an embodiment of the present invention which is capable of housing a plurality of spigots and kegs, wherein the doors of the housing are respectively closed and open;

FIG. 8A is a perspective front view drawing which illustrates a dispenser according to an embodiment of the present invention wherein its doors are closed;

FIGS. 8B-D are top-view drawings which illustrate a dispenser according to an embodiment of the present invention wherein a single ½ keg, two ¼ slim kegs, and three slim 5 gallon kegs are respectively provided;

FIG. 9 is a drawing which illustrates an upper column of a dispenser according to an embodiment of the present invention wherein the spigot comprises a removable handle; and

FIGS. 10 A-G respectively illustrate a perspective front view, front and back views, left and right-side views, as well as top and bottom views of an ornamental embodiment of a keg dispenser according to an embodiment of the present invention.

### DETAILED DESCRIPTION OF THE INVENTION

The terms “draft” and/or “kegs”, as used throughout the specification and claims, are used for the sake of simplicity and are intended to include any and all pressurized and/or pressurizable containers capable of containing a beverage and/or a component of a beverage.

The terms “line” and “lines”, as used throughout the specification and claims, are intended to include any structure, device, product, and/or component for the transmission and/or distribution of a fluid, including but not limited pipes, tubes, hoses, connections, and the like.

The term “column”, as used throughout the specification and claims, can be used interchangeably with the term “tower”, each of which are intended to include a housing and/or portion thereof, through which the draft lines attaching the spigot to the keg pass and is not limited to any particular shape.

The terms “a”, “an”, and “the” mean one or more.

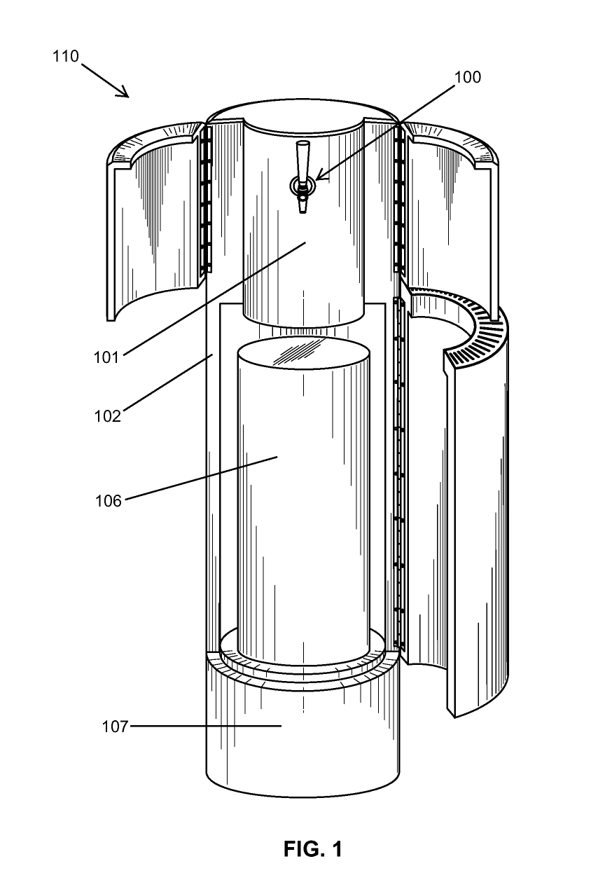

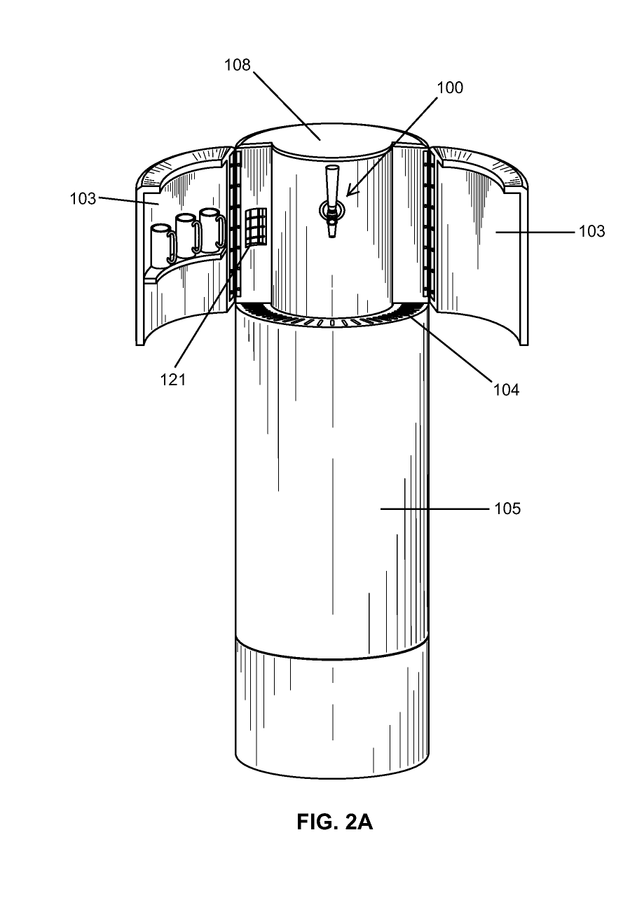

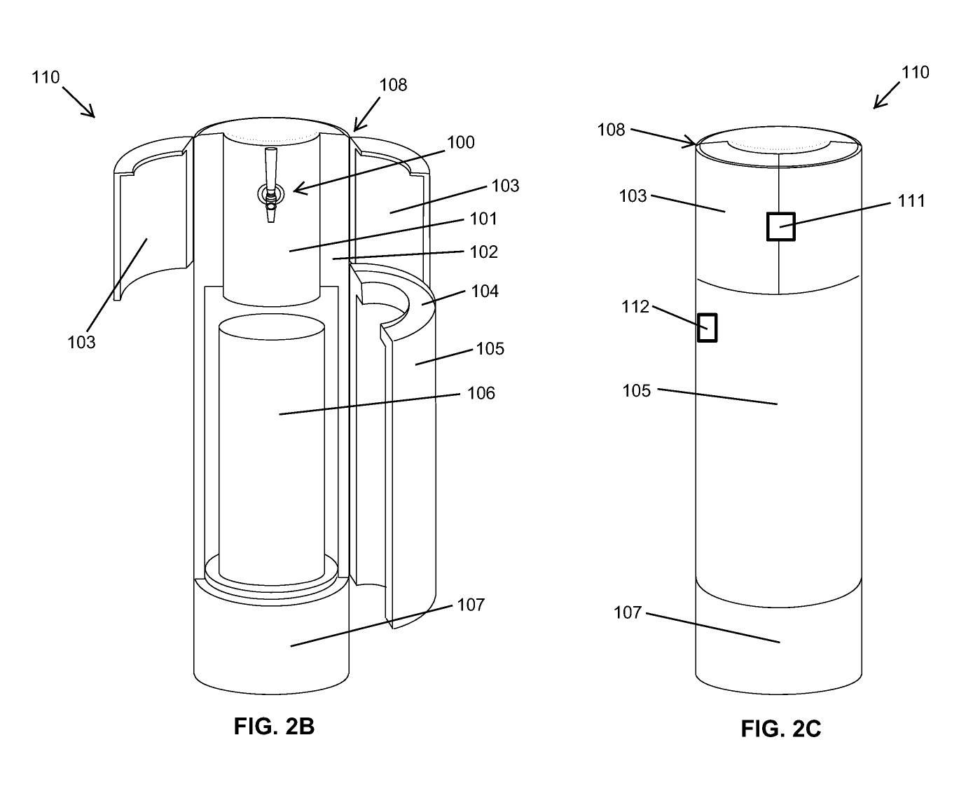

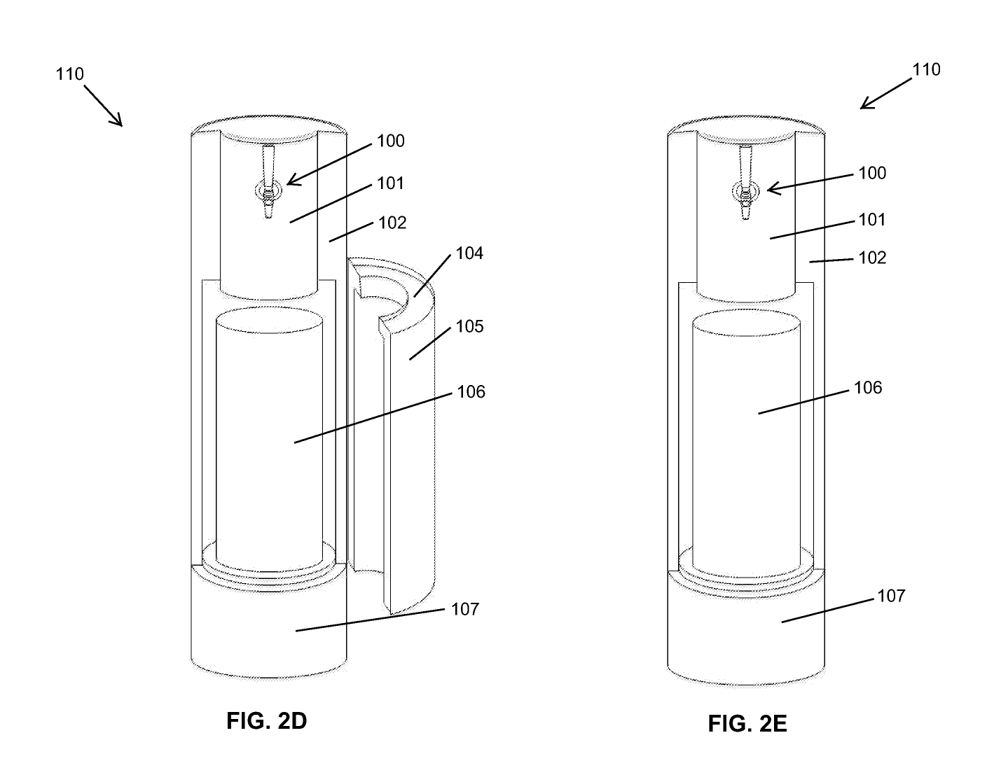

Referring now to FIGS. 1 and 2A-C, an embodiment of keg dispenser 110 is illustrated. In this embodiment, dispenser 110 preferably comprises spigot 100 attached to front portion 101 of upper column 108 of housing 102. Although numerous configurations and designs can optionally be incorporated into upper column 108, as best illustrated in FIG. 1, upper column 108 preferably comprises a large rear section and smaller front portion 101, such that the back portion of upper column 108 preferably comprises a larger diameter than front portion 101. Spigot 100 is preferably mounted on front portion 101. In this embodiment, when upper doors 103 are closed, they thus cause upper column 108 to substantially uniform outside diameter as illustrated in FIGS. 2A-C. In this embodiment, because spigot 100 protrudes from front portion 101 of upper column 108, upper doors 103 preferably comprise a protruding portion about a top portion of their inner radius of curvature, thereby creating an internal void around spigot 100 such that it is concealed when upper doors 103 are closed.

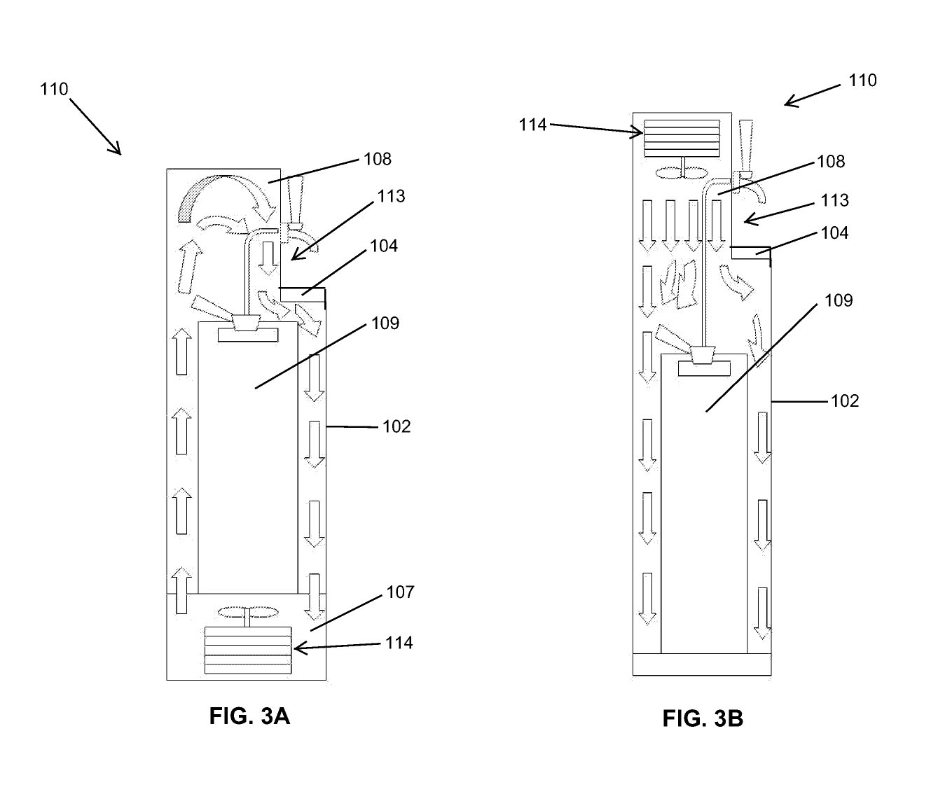

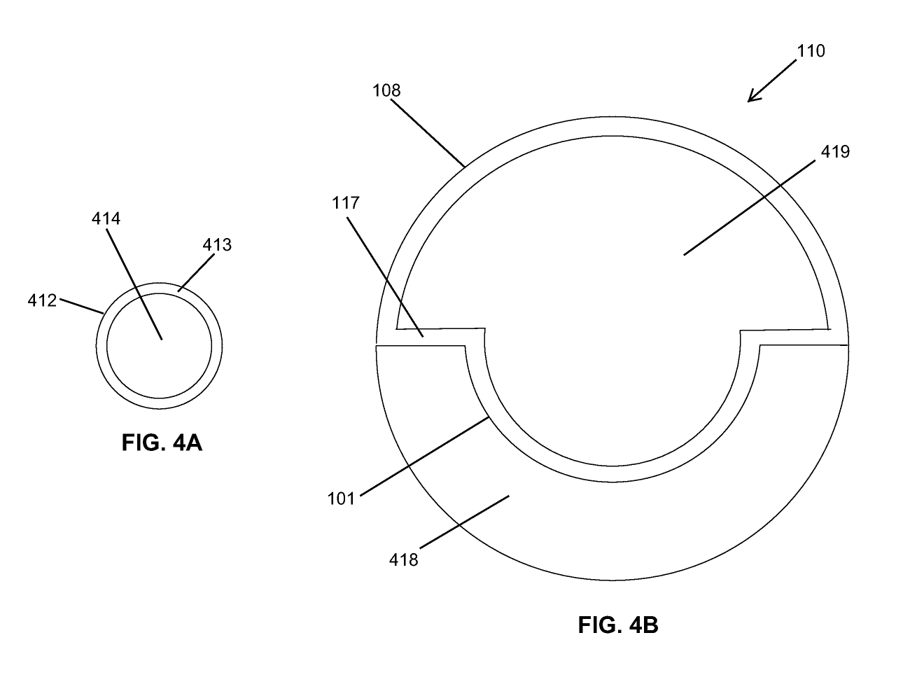

Housing 102 preferably comprises an internal void, which extends from cooling unit housing portion 107 through keg compartment 109 (see FIGS. 3A and 3B) and up to upper column 108, thereby maintaining a consistent temperature for a beverage traveling through such lines all the way from keg 106 to spigot 100. This ability to maintain a consistent temperature permits the beverage to be uniformly and properly chilled, thereby avoiding temperature-induced foam in carbonated beverages. In one embodiment, upper column 108 comprises cross-sectional internal area 419 (see FIG. 4B) of at least about 16 square inches and most preferably a cross-sectional area of at least about 24 square inches. This large cross-sectional area facilitates the flow of air around the tubing even at its connection to the spigot. The large opening for airflow also provides easy access to the spigot and line connection for maintenance, and repairs on dispenser 110. The draft lines attach form the keg 106 to the spigot 100 and can be of typical size and length according to the application of use.

By placing spigot 100 directly on front portion 101 of upper column 108, instead of on the end of a line which extends from housing 102, direct cooling and ventilation from cooling unit 114 (see FIG. 3), is provided, thus minimizing temperature-induced foam by allowing spigot 100 to be cooled with minimal obstruction, unlike conventional keg dispensers. This configuration also allows for the concealment of the draft-related connections and lines by creating an area built into housing 102 for spigot 100 to attach to.

In one embodiment, front portion 101 of upper column 108 has a frontal diameter of about three to about four inches smaller than the outside diameter of housing 102. By providing a smaller diameter of front portion 101, which is containable within doors 103, not only is spigot 100 concealable, but drip tray 104 can thus also be contained within an upper portion of lower door 105, such that drip tray 104 resides under spigot when lower door 105 is closed. Because drip tray 104 is housed within an upper portion of door 105, when upper doors 103 are closed, not only is spigot 100 concealed, but drip tray 104 is also concealed. In an alternative embodiment, upper doors 103 can be shortened and a drip tray can be incorporated into a portion of housing 102 which wraps around the front of dispenser 110 between the upper doors and the lower door.

Optionally drip tray 104 can include a recess within which a removable drip tray can be disposed. This removable drip tray thus allows for easy cleaning and draining. In an alternative embodiment, drip tray 104 can simply comprise a recess which contains a dripped liquid. In either embodiment, a line can be connected to drip tray 104 such that liquids which are captured by drip tray 104 are led to a predetermined area, which can include a capture container, a sewer drain, and/or a heated evaporating tray.

Optionally, doors 103 can include locking mechanism 111, which aids in keeping unauthorized people, such as children, from dispensing the beverage housed therein. Lower door 105 can also optionally include locking mechanism 112. Although cooling unit 114 (see FIG. 3), and cooling unit housing 107 is illustrated as being disposed below keg compartment 109, it can be placed anywhere within or on dispenser 110 and can rely on any known system, apparatus, mechanism, method, and/or combination thereof capable of cooling a beverage to a desirable temperature, including but not limited to adiabatic cooling of a compressed refrigerant, Peltier-effect-based electro-thermal coolers, evaporative cooling, combinations thereof, and the like. In an alternative embodiment, cooling unit housing 107 can optionally be omitted and the cooling unit instead be incorporated into another portion of housing 102, this is particularly true for diminutively-sized thermo-electric coolers.

In one embodiment, one or more vents 121 (see FIG. 2A) can be provided through upper column 108 which permits chilled air to enter the area between closed doors 103 and front portion 101 of upper column 108. In this embodiment, drinking containers, can be stored within the confines of enter the area between closed doors 103 and front portion 101 of upper column 108. Accordingly, a user can obtain a chilled drinking container stored therein prior to dispensing a beverage from spigot 100 into the glass. Optionally, one or more vents 121 can be replaced with one or more cooling plates, such as a Peltier thermo-electric cooler. This not only provides a user with a pre-chilled glass, if so desired, but the chilled air which accumulates within the confines of the area between closed doors 103 and front portion 101 of upper column 108, when such doors are closed, also chills spigot 100, thus further avoiding thermal-induced foaming of a dispensed beverage. Still further, a pre-chilled glass also reduced thermal-induced foaming and permits the user to maintain a served beverage at a colder temperature for a longer period of time. Optionally, the cooling plates can be disposed below drip tray 104, such that not only is the internal space between closed doors 103 and front portion 101 of upper column 108 chilled, but also such that while top doors 103 are open, a user can place his or her drinking container on the drip tray, thereby keeping the beverage contained in the drinking container colder for a longer period of time. Optionally, vents 121 can be configured such that they are closed and/or airflow to them is blocked when one or more of doors 103 are opened, thus preventing cooled air from being vented to outside ambient air.

As best illustrated in FIG. 2D, in one embodiment, dispenser 110 can comprise bottom door 105, but no top doors. In this embodiment, spigot 100 remains visible when dispenser 110 is in use and when dispenser 110 is not in use. FIG. 2E illustrates an embodiment of the present invention wherein dispenser 110 does not include keg compartment door 105, nor does it include top doors 103. In one embodiment, dispenser 110 can comprise upper doors 103 but not a compartment door. In one embodiment, keg 106 can be chilled prior to placement into dispenser 110. Optionally, keg 106 can be disposed in an ice bucket or other cooling container and disposed into dispenser 110.

FIGS. 3A and 3B schematically illustrate the flow of chilled air within dispenser 110 according to an embodiment of the invention. The recessed-configuration of upper column 108, as taught in an embodiment of the present invention, permits its lower portion to remain open to the flow of chilled air, while simultaneously providing a concealable spigot and drip tray. Disposing cooling unit 114 and cooling unit housing 107 at the bottom of dispenser 110 as illustrated in FIG. 3A, allows chilled air to flow throughout housing 102, including through keg compartment 109, thereby chilling not only a keg, but also the beverage distribution lines which connect the keg to a spigot. Alternatively, desirable results are also obtained when cooling unit 114 is instead disposed within upper column 108, as illustrated in FIG. 3B. In this configuration, the chilled air flows down cooling unit 114 through keg compartment 109, before circulating back up to cooling unit 114. Thereby eliminating the need for the cooling unit housing illustrated at the bottom of dispenser 110 in FIG. 3.

In one embodiment of the present invention, wherein top doors 103 are or are not provided, rabbeted shape 113 (see FIGS. 3A and B) is preferably formed due to a lower portion of dispenser 110 protruding further than upper column 108. In one embodiment, rabbeted shape 113 can optionally be formed between upper column 108 and drip tray 104. In one embodiment, front portion 101 of upper column 108 can optionally comprise a substantially planar shape.

FIG. 4A illustrates a traditional keg dispensing column 412, which has an exterior diameter of about four inches and approximately ½ an inch of insulation 413, thus leaving opening interior 414 of only about three inches diameter for air to flow. Compare this small interior air-flow diameter with the same-scale drawing of an embodiment of dispenser 110 of the present invention as illustrated in FIG. 4B. As illustrated therein, the large size of upper column 108, in conjunction with the smaller-diameter front portion 101 allows for the use of thicker insulation 117 (optionally about one inch thick), without limiting air flow nearly as much as that encountered in conventional keg-dispensers. This configuration also creates seat 418 for the placement of drip tray 104 that can easily be concealed. Further, the smaller diameter front portion 101 of upper column 108 allows for the optional placement of multiple spigots without drastically restricting airflow to the spigots as is encountered in conventional keg-dispensers. This increased flow of chilled air around the lines connecting the one or more spigots, thus reduces the temperature of the beverage contained in the end portion of the lines, thereby allowing the first-served beverage to be colder than that of a typical dispenser, without the need to install an additional blower to force the cold air around the lines.

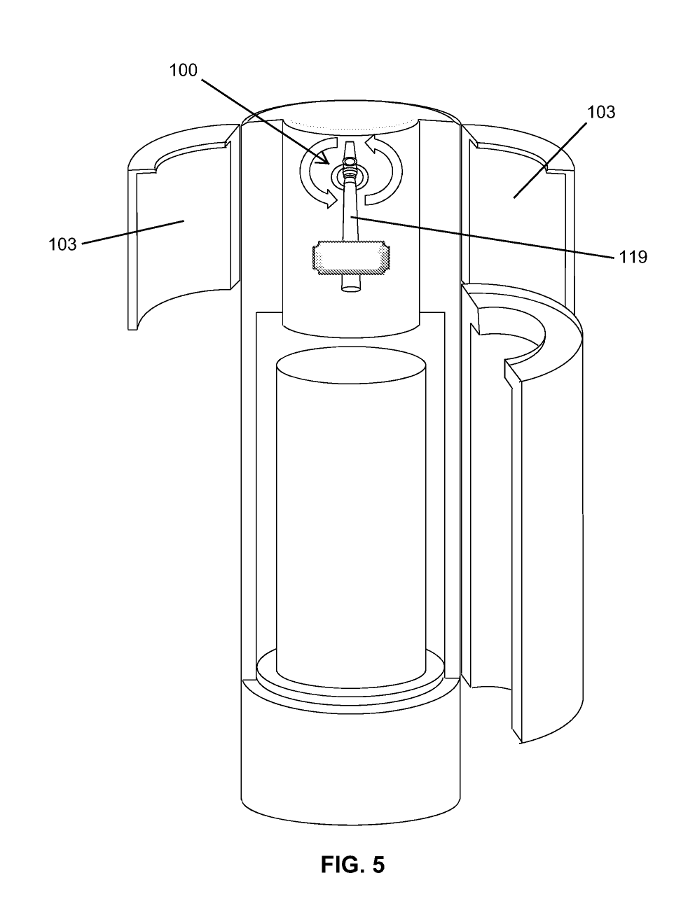

As illustrated in FIG. 5, spigot 100 can optionally be rotationally coupled to accommodate handle 119 having an extended length such that spigot 100 can be rotated to permit handle to reside within the confines created by upper doors 103. In this embodiment, spigot 100 can rotate approximately 180 degrees or more. Optionally, a release mechanism (not shown) can be provided to lock spigot 100 into an up and/or down position. The release mechanism can be any known mechanism.

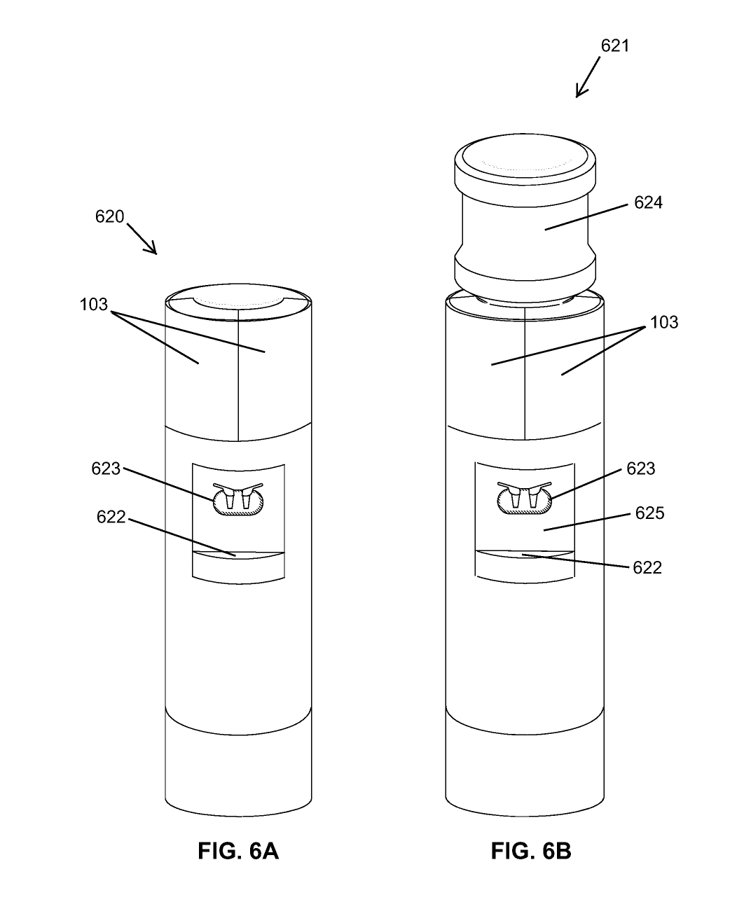

Referring now to FIGS. 6A and B, multi-purpose dispensers 620 and 621 are illustrated in which the dispenser is made to either appear to resemble a conventional water-cooler or actually dispense water in conjunction with a beverage contained in a pressurized and/or pressurizable keg. In the two illustrated embodiments, drip tray 622 and one or more spigots 623, which can resemble spigots on a conventional water-cooler, are placed on the housing door—one or more of which can protrude out slightly. As illustrated in FIG. 6A, if it is desired, a water line, similar to those used in residential refrigerators, can optionally be provided and connected to a filtration system which in turn can be attached to dispenser 620. As illustrated in FIG. 6B, water bottle 624 can optionally be connected to an input tap disposed in an upper end of dispenser 621, including but not limited to conventionally known water-cooler systems. In each of these embodiments, water can optionally be dispensed from one of the spigots and a beverage from a keg can be dispensed from the other. Optionally, a cooling compartment can be provided within either of dispensers 620 or 621, such that chilled water can be dispensed. Spigots 623 are optionally disposed within spigot bay 625. Optionally, in one embodiment, dispenser 620 and/or 621 can optionally include one or more upper doors 103, which can be opened to reveal a spigot which dispenses beverage from a keg contained within the dispenser. In this embodiment, a user can optionally have a plurality of water spigots in an open and conspicuous spigot bay 625, such that dispenser 620 and/or 621 can resemble a functioning and conventionally-shaped water-cooler, while simultaneously functioning as a keg dispenser. Optionally, the water supply can be disconnected from the spigots in spigot bay 625 such that those spigots do not operate or such that one or more of them dispense beverage from a keg contained within dispenser 620 and/or 621.

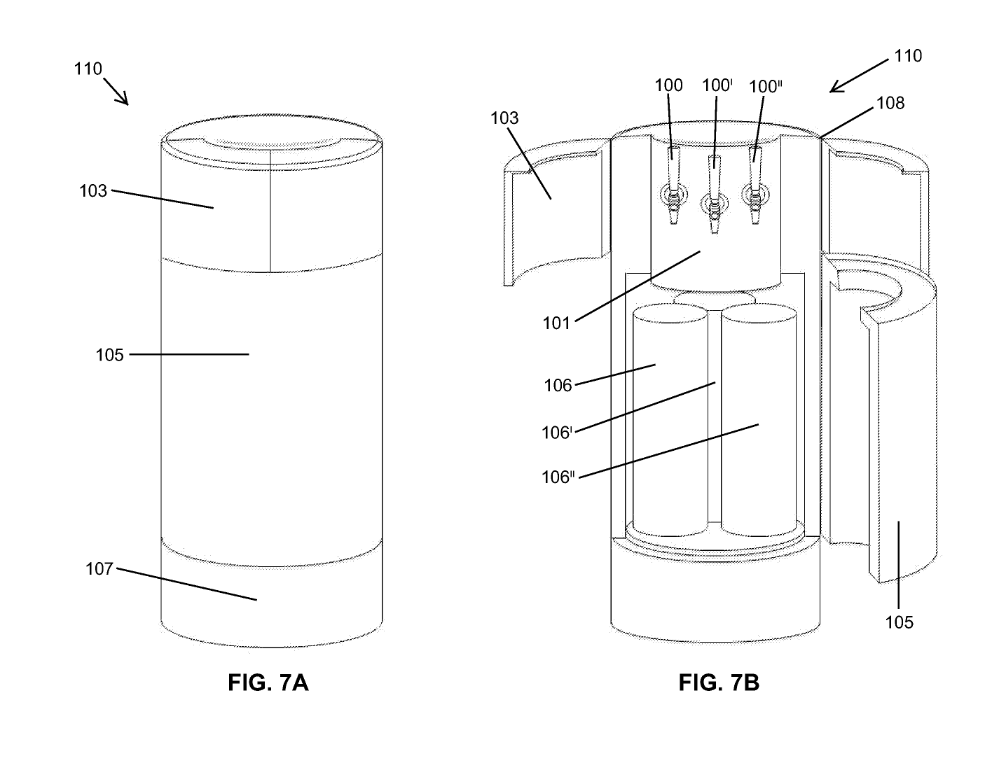

Referring now to FIGS. 7A and B, according to yet another embodiment of the present invention, foam resistant keg dispenser 110 can be provided with an increased diameter in order to dispense one ½ barrel keg, or multiple slim kegs 106, 106′ and 106″. In this embodiment, the increased diameter of dispenser 110 also increases the size of front portion 101 of upper column 108, thus permitting a plurality of spigots 100, 100′, and 100″ to be accommodated. Still further, the increased diameter of dispenser 110 also increases the cross-sectional area of upper column 108, which in turn permits multiple tap lines to be contained while simultaneously increasing the amount of chilled airflow thereto.

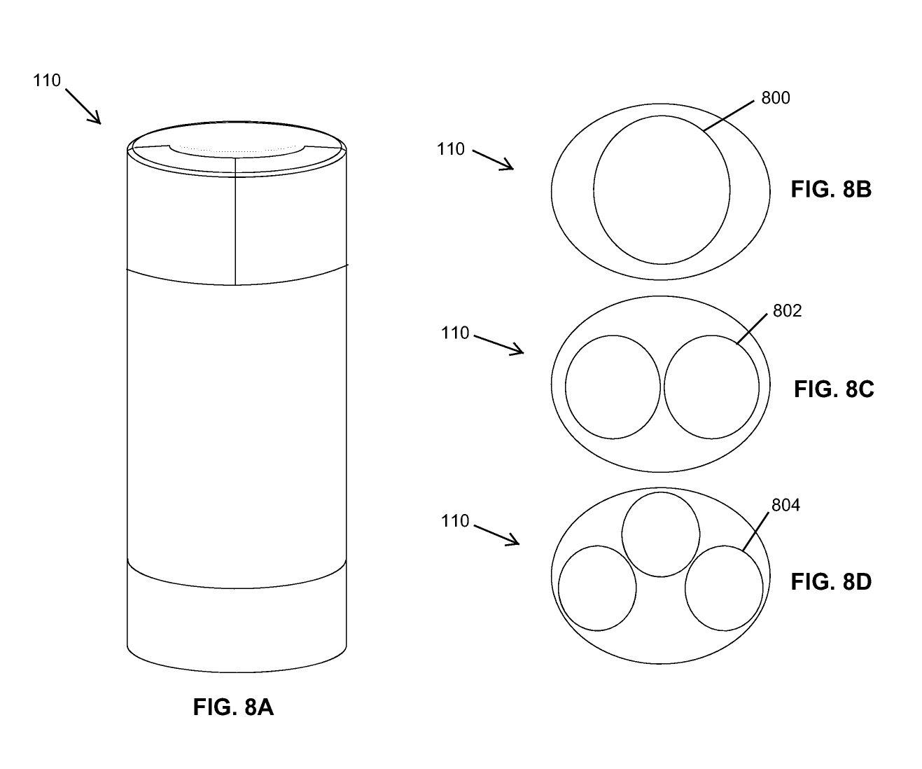

FIG. 8A illustrates a front-perspective view drawing of an embodiment of dispenser 110 similar to that illustrated in FIGS. 7A and B, except that instead of the substantially circular cross sectional shape illustrated in those Figs, the embodiment of dispenser 110 illustrated in FIGS. 8A-D instead comprises a more oval-shaped cross sectional shape. FIG. 8B is a top view drawing which schematically illustrates the placement of a single large keg 800, a pair of smaller kegs 802, and a trio of smaller kegs 804. For example, in one embodiment, dispenser 110 can comprise an oval shape and can accommodate a ½ keg, a pair of ¼ slim kegs, or a trio of ⅙ slim kegs. As illustrated, the oval-shaped cross section shape helps reduce the footprint of dispenser 110 while still permitting it to accommodate several different combinations of kegs and while still maintaining an aesthetically-attractive appearance.

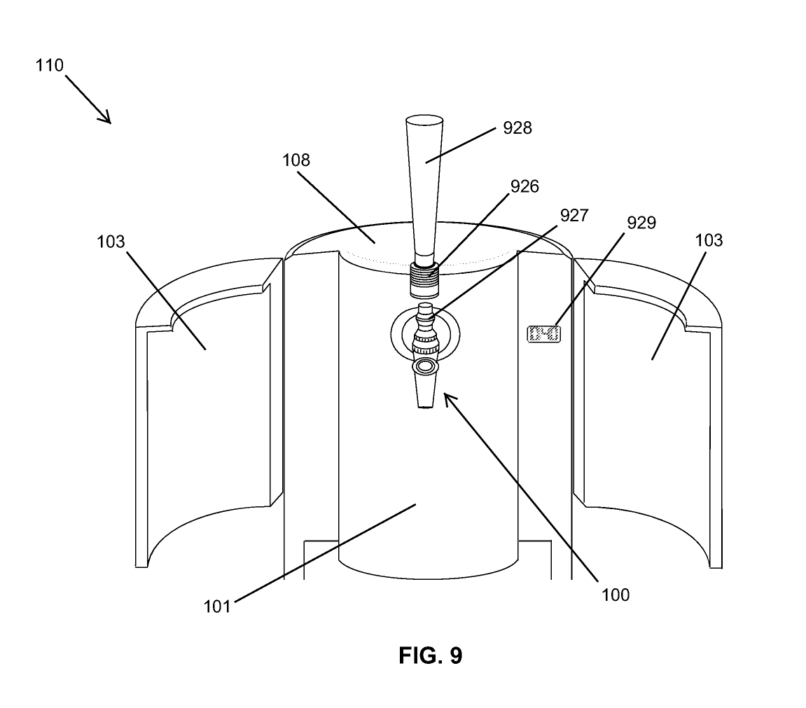

Referring now to FIG. 9, in one embodiment, dispenser 110 can comprise spigot 100 having removably-connectable handle 928. Optionally, handle 928 can comprise a female coupler 926, which can be a quick-connect coupler, while spigot 100 can comprise a male coupler 927, which can also be a quick-connect coupler, or vice-a-versa. This configuration allows for the easy connection and disconnection of the tap handle 928 to spigot 100. This arrangement also provides the ability to install spigot 100 higher up on front portion 101, while still permitting upper doors 103 to be closed after handle 928 is removed. This is favorable because it allows for the use of taller glassware. Alternatively, disposing spigot 100 nearer the top of front portion 101 permits top cylinder 108 to be shortened, thus reducing the overall height of dispenser 110. Still further, a locking mechanism (not illustrated) can be attached directly on the spigot itself covering the male coupler and having a keyed release mechanism such that spigot 100 cannot be operated without the proper key.

With the ability to quickly connect and disconnect handle 928, a user can also optionally keep a plurality of color-coded couplers, spigots, and/or tap handles, thereby providing a manner to ensure that proper tap handles are attached to the proper spigot, particularly for those embodiments which provide a plurality of spigots.

Still another embodiment of the present invention provides a user with the ability to monitor temperature and/or remaining quantity of a beverage remaining within the keg. The temperature can be monitored via the use of one or more temperature sensors and the one or more temperature levels can be displayed on display 929 (see FIG. 9), which can optionally include a liquid-crystal display, a light-emitting-diode display, or another electrical display apparatus. The remaining capacity of the keg can optionally be determined by a pressure sensor which compares the actual weight of the keg and its contents to a weight of an empty keg. The keg fluid level can be displayed on display 929. In an embodiment wherein both temperature and keg-levels are displayed, they can optionally both be displayed on display 929, or can be displayed to separate display devices.

Referring now to the figures generally, in one embodiment, hinges for one or more of doors 103 and/or 105 are preferably concealed when closed. In one embodiment, spigot 100 is not disposed on a top surface of dispenser the dispenser or on a top surface of upper column 101. In one embodiment, the dispenser is not cooled by, nor does it rely on ice or another substance that is cooled prior to placing it within dispenser 110. In one embodiment, upper column 101 is not cylindrical. In one embodiment, the cooling unit of the invention comprises only a single fan for circulating cooled air and does not comprise an additional blower for forcing chilled air into an area surrounding tap lines. In one embodiment, keg 106 can comprise any ready-to-drink beverage. Optionally, keg 106 can comprise any ready-drink-carbonated beverage. In one embodiment, keg 106 does not comprise a bag-in-a-box or a component thereof.

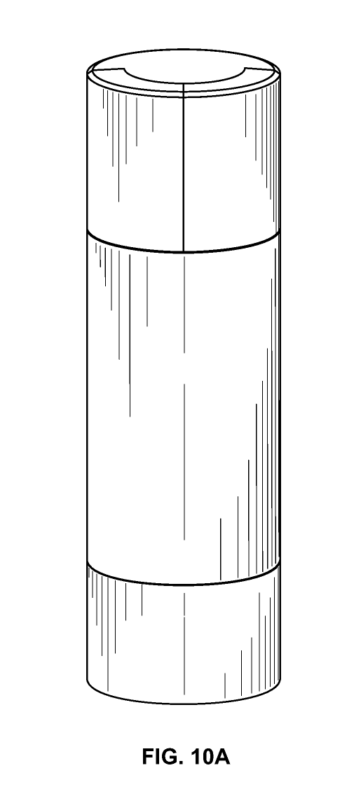

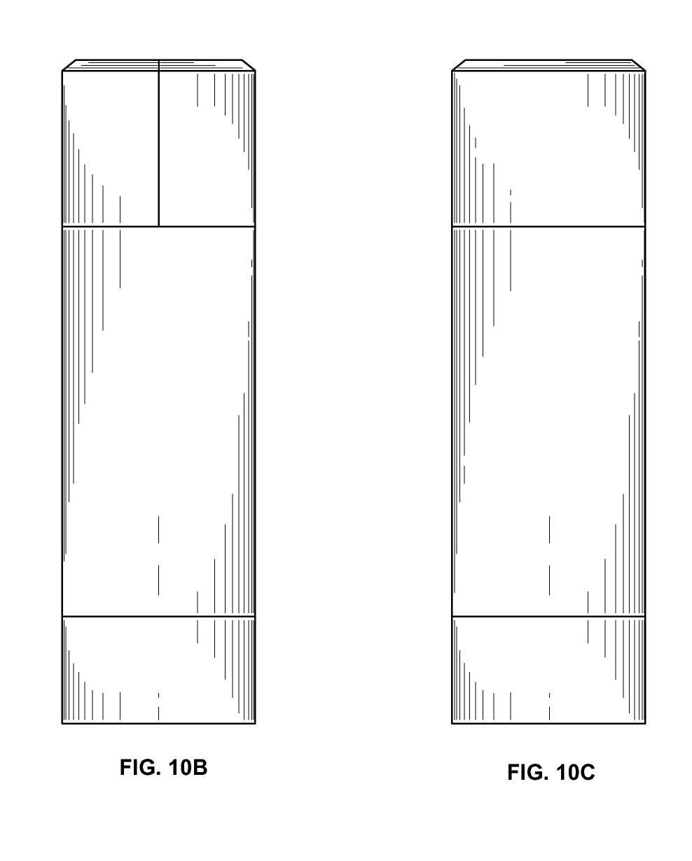

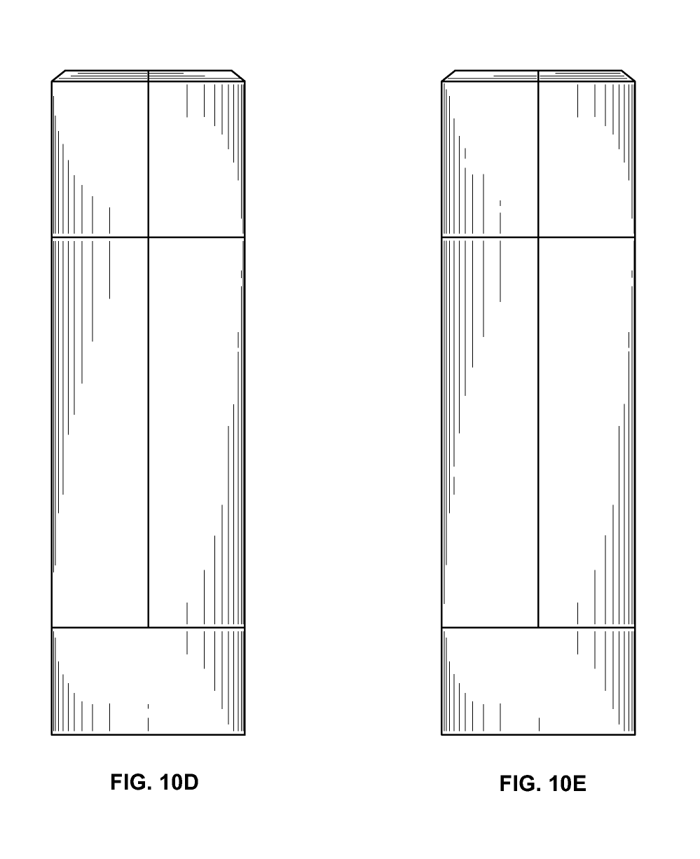

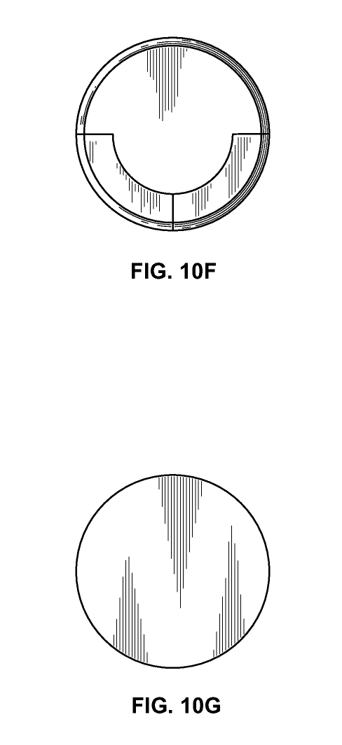

FIG. 10 A-G respectively illustrate a perspective front view, front and back views, left and right-side views, as well as top and bottom views of an ornamental embodiment of a keg dispenser according to an embodiment of the present invention.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above and/or in the attachments, and of the corresponding application(s), are hereby incorporated by reference.

What is claimed is:

1. A beverage dispensing apparatus comprising:
an upper column, said upper column comprising:
one or more upper doors; and
a spigot, said spigot concealed when said doors are closed; and
a keg compartment.

2. The apparatus of claim 1 wherein said keg compartment is cooled by a cooling unit.

3. The apparatus of claim 2 wherein said cooling unit relies on adiabatic cooling of a compressed refrigerant.

4. The apparatus of claim 2 wherein said cooling unit comprises a Peltier-effect-based thermo electric cooler.

5. The apparatus of claim 2 wherein said keg compartment comprises a door having a drip tray disposed in an upper end thereof.

6. The apparatus of claim 1 wherein said keg compartment is disposed below said upper column.

7. The apparatus of claim 1 wherein said spigot is disposed on a front portion of said upper column.

8. The apparatus of claim 1 wherein said spigot is not disposed on a top surface of said dispensing apparatus.

9. The apparatus of claim 1 wherein said upper column is not cylindrical.

10. The apparatus of claim 1 wherein said upper column comprises at least two different radiuses of curvature.

11. The apparatus of claim 1 wherein said upper column comprises two upper doors and wherein said keg compartment comprises only one door.

12. The apparatus of claim 1 wherein said upper column comprises a cool air entrance opening comprising a cross-sectional area of at least 24 square inches, within which at least a terminal portion of a line lies.

13. The apparatus of claim 12 wherein said cool air entrance opening is communicably coupled to an interior of said keg compartment and not to ambient air when a door of said keg compartment is closed and said upper doors are open.

14. The apparatus of claim 12 wherein said cool air entrance opening is communicable with ambient air when a door of said keg compartment is open, but not when said door is closed.

15. The apparatus of claim 1 wherein said spigot can be rotated about a substantially horizontal axis.

16. The apparatus of claim 1 further comprising a quick-couple spigot handle.

17. The apparatus of claim 1 comprising a plurality of spigots.

18. The apparatus of claim 1 wherein said keg compartment comprises internal dimensions which accommodate a plurality of slim kegs.

19. The apparatus of claim 1 further comprising a vent disposed in said upper column, said vent communicable with an area formed between said one or more upper doors and said upper column.

20. A beverage dispensing apparatus comprising:
an upper column, said upper column comprising:
two or more upper doors; and
a spigot, said spigot concealed when said doors are closed; and
a keg compartment; and
said dispenser comprising an elongated cylindrical shape.

21. A beverage dispensing apparatus comprising:
a substantially cylindrical shape;
a cooled keg compartment;
a first spigot communicably coupled to a keg tap;
a second spigot communicably coupled to a water source; and
wherein said spigots are secured within a spigot bay, said spigot bay formed into a portion of said substantially cylindrical shape.

22. A beverage dispensing apparatus comprising:
a keg containing compartment;
an upper column, said upper column comprising a spigot, wherein an outer portion of said upper column is recessed from an outer portion of said keg compartment, thereby forming a rabbeted shape.
